(19) United States
(12) Patent Application Publication
(10) Pub. No.: US 2011/0241533 A1
(43) Pub. Date: Oct. 6, 2011

(54) ELECTRON-EMITTING DEVICE AND IMAGE DISPLAY APPARATUS USING THE ELECTRON-EMITTING DEVICE

(75) Inventors: Norihiko Ochi, Sagamihara-shi (JP); Kenichi Iwata, Fujisawa-shi (JP)

(73) Assignee: CANON KABUSHIKI KAISHA, Tokyo (JP)

(21) Appl. No.: 12/526,811

(22) PCT Filed: Apr. 10, 2009
(86) PCT No.: PCT/JP2009/057712

§ 371 Date: Aug. 12, 2009

(30) Foreign Application Priority Data
Dec. 19, 2008 (JP) 2008-324463

(51) Int. Cl. H01J 1/62; H01J 9/02

(52) U.S. Cl. 313/483; 313/310

(57) ABSTRACT

An electron-emitting device has at least a cathode electrode, an electron-emitting member which is electrically connected to the cathode electrode, and a resistive layer which is provided between the cathode electrode and the electron-emitting member. The resistive layer is composed of the same material as that of the electron-emitting member, and film density of the resistive layer is lower than film density of the electron-emitting member.

### TECHNICAL FIELD

The present invention relates to an electron-emitting device and an image display apparatus using the electron-emitting device.

### BACKGROUND ART

In field emission electron-emitting devices, generally a voltage is applied between an electron-emitting member (emitter) and a gate electrode so that a strong electric field is generated on a surface of an end of the electron-emitting member, and electrons are field-emitted from the surface of the electron-emitting member into vacuum A lot of field emission electron-emitting devices are arranged on a substrate (rear plate) so that an electron source can be constituted. When a substrate (face plate) which is provided with a light-emitting member such as phosphor, like CRT, to emit light due to irradiation of an electron beam is opposed to the rear plate and peripheries of both the substrates are sealed, an image display apparatus can be constituted.

In some electron-emitting devices, the electrons which are field-emitted from an electron-emitting portion once collide with the opposed gate electrode and scatter, and then are taken out as emitted electrons (Japanese Patent Application Laid-Open No. 2001-167693).

In the field emission electron-emitting devices, a resistance (including fuse) is provided between the electron-emitting member and a cathode electrode in order to stabilize electron emission current or suppress overcurrent (unintentional high current or discharge current).

Japanese Patent Application Laid-Open No. 1-154426 discloses that the electron-emitting member and the cathode electrode are laminated and a resistive layer is provided between the electron-emitting member and the cathode electrode. Japanese Patent Application Laid-Open No. 4-292831 discloses a constitution where a cathode electrode is not provided below a resistive layer positioned below the emitter in order to allow a defect such as a pinhole of the resistive layer. Japanese Patent Application Laid-Open No. 4-284324 discloses that apart of a gate wiring connected to the gate electrode is a soluble resistive member for each electron-emitting device.

### DISCLOSURE OF INVENTION

When the resistive member is formed by a material different from that to be the electron-emitting member, a manufacturing process becomes complicated and the cost rises. When they are formed by the same material, a film thickness should be made to be thin in order to increase resistance in the form that the electron-emitting member and the resistive layer are laminated. For this reason, a high film thickness control technique is required. When the film thickness is made to be too thin, a defect such as a pinhole is generated, and thus even when the constitution is changed in order to avoid the defect such as the pinhole, a special patterning process is required. For this reason, the cost rises. Even when resistance is provided to the gate side, a special patterning process is required, thereby causing a rise in the cost. Further, the electron-emitting member and the resistive layer are not laminated but they are arranged on the substrate adjacent to each other. However, the process becomes complicated and also a length of the resistive layer should be enlarged (a layout area should be enlarged) in order to increase the resistance. As a result, an area occupied by the electron-emitting device (resistance layout area) becomes large, and thus this is disadvantageous to high definition of the image display apparatus.

The present invention is devised in order to solve the above problem, and provides an electron-emitting device which has at least a cathode electrode; an electron-emitting member which is electrically connected to the cathode electrode; and a resistive layer provided between the cathode electrode and the electron-emitting member. The resistive layer is composed of the same material as that of the electron-emitting member, and film density of the resistive layer is lower than film density of the electron-emitting member.

The electron-emitting member and the resistive layer are composed of the same conductive material, and only film density of the conductive materials is changed so that the electron-emitting member and the resistive layer can be easily manufactured. As a result, a rise in the manufacturing cost can be suppressed. Further, in a constitution of a vertical type electron-emitting device, the resistive layer is formed on the side surface of the insulating layer, so that high resistance is achieved, and an area occupied by the electron-emitting device can be reduced. That is to say, the electron-emitting device which is suitable for a high-definition image display apparatus can be provided.

Further features of the present invention will become apparent from the following description of exemplary embodiments with reference to the attached drawings.

### BRIEF DESCRIPTION OF DRAWINGS

FIGS. 1A to 1C are schematic diagrams illustrating an electron-emitting device.

FIGS. 2A and 2B are schematic diagrams illustrating other electron-emitting device.

FIG. 3 is a diagram illustrating a shape of resistive member connected to the electron-emitting device.

FIG. 4 is a diagram illustrating a relationship among between film density and resistivity of the resistive member.

FIG. 5 is a diagram illustrating a relationship between a value of overcurrent and temperature of the resistive member.

FIG. 6 is a diagram illustrating a relationship between film density of the resistive member and a current threshold for fusing.

FIG. 7 is a diagram illustrating damage of the electron-emitting device at the time when overcurrent flows.

FIGS. 8A to 8G are diagrams illustrating examples of a method of manufacturing the electron-emitting device.

FIG. 9 is a diagram illustrating a relationship between a film deposition angle and resistivity.

FIG. 10 is a partial diagram illustrating the electron-emitting device according to a example.

FIG. 11 is a diagram illustrating a relationship between a voltage and an electric current.

FIG. 12 is a diagram explaining a constitution for measuring a characteristic of the electron-emitting device.

FIGS. 13A to 13C are diagrams illustrating a relationship between before and after the overcurrent.

FIGS. 14A to 14C are explanatory diagrams about an etching process.

FIG. 15 is an explanatory diagram illustrating an electron source where the electron-emitting devices are arranged.

FIG. 16 is an explanatory diagram illustrating an image display apparatus using the electron-emitting device.

FIG. 17 is a circuit diagram illustrating one example of a drive circuit for driving the image display apparatus.

### DESCRIPTION OF EMBODIMENTS

Preferred embodiments of the present invention are described in detail below with reference to the drawings.

The scope of the present invention is not limited to dimensions, materials, shapes and relative arrangements of components described in the embodiments unless otherwise noted.

A constitution of one example of an electron-emitting device according to the embodiment is described.

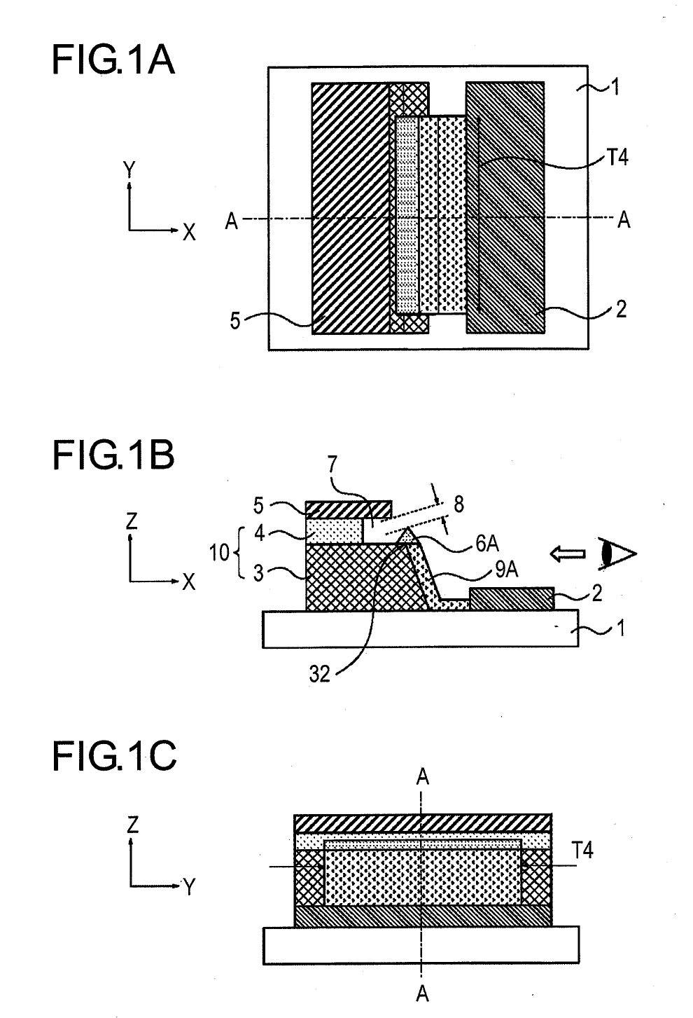

FIG. 1A is a plan schematic diagram of the electron-emitting device, and FIG. 1B is a cross-sectional view taken along A-A line (A-A line in FIG. 1C) in FIG. 1A. FIG. 1C is a side view when the electron-emitting device is viewed from a direction of an arrow in FIG. 1B.

An insulating step forming member 10 and a cathode electrode 2 are arranged adjacent to each other on a substrate 1. The step forming member 10 is formed by a first insulating layer 3 and a second insulating layer 4 which are laminated. A resistive layer 9A is arranged on a slope as a side surface of the first insulating layer 3 on a cathode electrode 2 side along the slope. At least a part of an electron-emitting member 6A is arranged on an upper surface of the first insulating layer 3. At least a part of the electron-emitting member 6A is arranged on a corner portion (edge portion) 32 of the insulating layer 3. The resistive layer 9A and the electron-emitting member 6A are connected to each other. In FIG. 1B, for easy understanding, the resistive layer 9A and the electron-emitting member 6A are shown separately in a clear manner, but since the resistive layer 9A and the electron-emitting member 6A are made of the same material, occasionally their boundary is not actually clear.

Therefore, it can be said that a part (9A) of a conductive film (9A+6A) having the resistive layer 9A and the electron-emitting member 6A is arranged on the slope as the side surface of the first insulating layer 3 on the cathode electrode 2 side along this slope. Further, the conductive film (9A+6A) covers the slope (side surface), the upper surface and the corner portion 32 of the first insulating layer 3. Further, the conductive film (9A+6A) extends from the cathode electrode 2 into a recess portion 7 of the step forming member 10.

In other words, the conductive film (9A+6A) has a resistive portion 9A and an electron-emitting portion 6A. That is to say, in this case, the resistive layer corresponds to the resistive portion, and the electron-emitting member corresponds to the electron-emitting portion.

The corner portion 32 of the first insulating layer 3 is a portion where the upper surface and the side surface of the first insulating layer 3 are connected (or communicate each other). The corner portion 32 may be a portion where the upper surface (side surface) of the first insulating layer 3 is connected to the side surface (upper surface). The corner portion 32 may have a form without curvature (namely, a form that an edge of the upper surface and an edge of the side surface collide with each other), or a form with curvature. That is to say, the upper surface and the side surface of the first insulating layer 3 can be connected via the portion having a predetermined curvature radius (corner portion 32). When the corner portion 32 has the curvature, the conductive film (9A+6A) can be formed stably, and thus is advantageous from a viewpoint of the electron emission characteristic of the electron-emitting device.

One end portion of the resistive layer 9A is electrically connected to the cathode electrode 2, and the other end portion of the resistive layer 9A is electrically connected to the electron-emitting member 6A. The electron-emitting member 6A can be called as a protruding portion having a pointed tip. Therefore, the protruding portion is provided onto the corner portion (the portion where the upper surface and the side surface of the first insulating layer 3 are connected) 32 of the first insulating layer 3. The end of the protruding portion is separated from the surface of the substrate 1 farther than the upper surface of the first insulating layer 3, and is pointed.

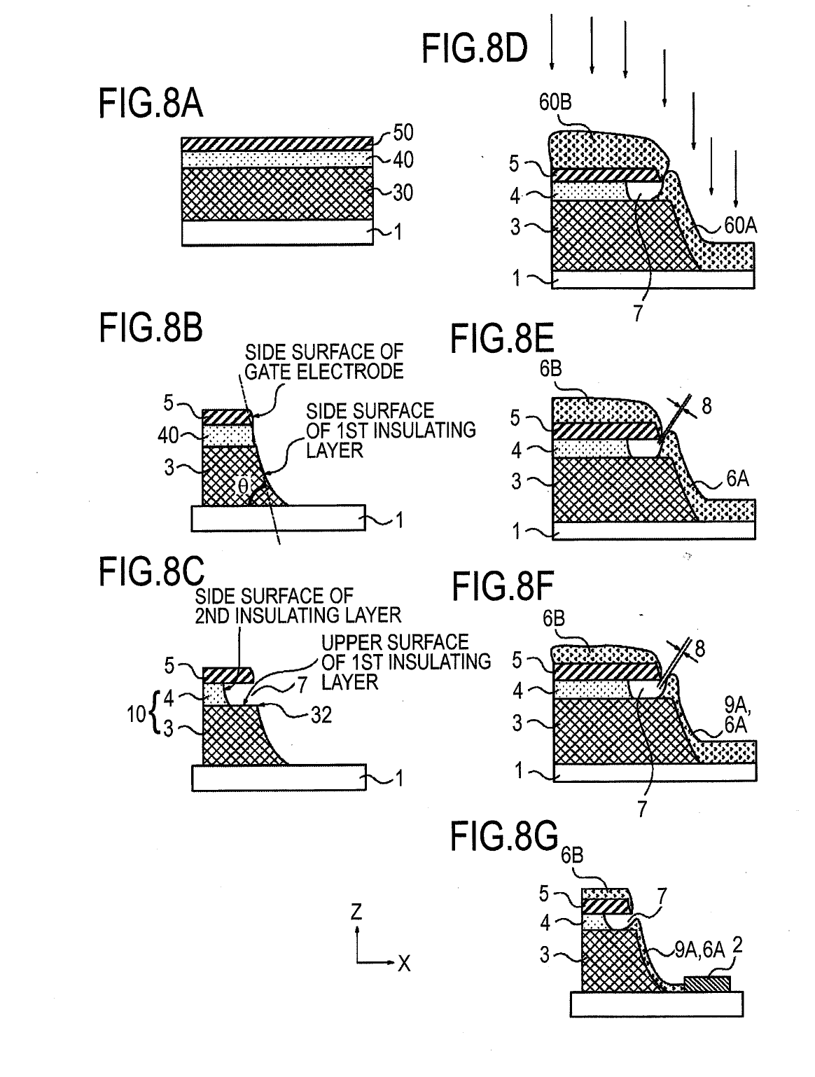

The gate electrode 5 is separated from the first insulating layer by a predetermined distance (a thickness of the second insulating layer) via the second insulating layer 4 provided between the gate electrode 5 and the first insulating layer 3. As described later, a conductive film 6B is occasionally provided onto the gate electrode 5 (see FIG. 8). In this case, the member 5 and the member 6B can be called as a gate electrode. An arrangement position of the gate electrode 5 is not limited to the mode shown in FIG. 1B. That is to say, the gate electrode 5 may be arranged at a predetermined gap with respect to the electron-emitting member 6A so that an electric field for enabling field emission to the electron-emitting member 6A can be applied. In this case, the second insulating layer 4 is not occasionally required.

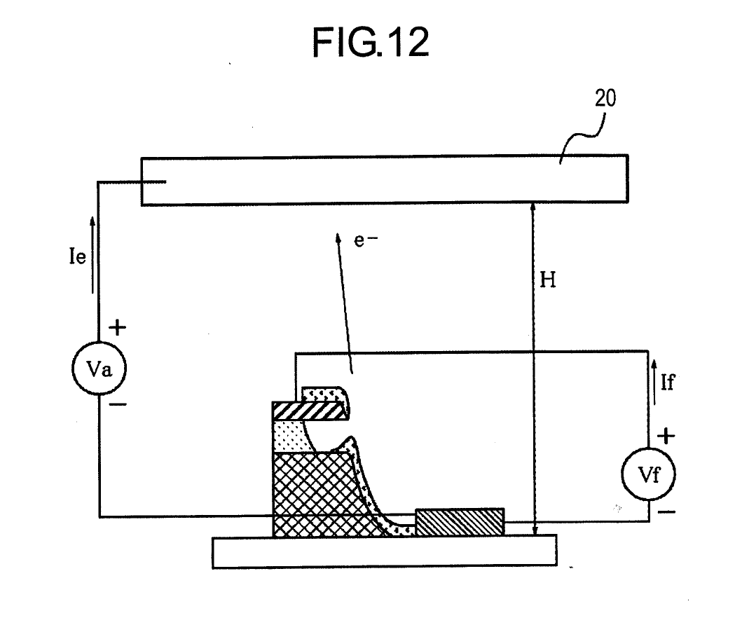

When a drive voltage is applied between the cathode electrode 2 and the gate electrode 5 so that the electric potential of the gate electrode 5 becomes higher than that of the cathode electrode 2, electrons are field-emitted from the end of the electron-emitting member 6A. The electron-emitting member 6A occasionally has a coating film made of a low-work function material on its surface. In this case, the electrons are field-emitted from the film made of the low-work function material positioned at the end of the electron-emitting member 6A. As not shown in FIG. 1B, but an anode electrode 20 whose potential is defined to be higher than that of the gate electrode is arranged above the substrate 1 (position separated further than gate electrode 5) (see FIG. 12).

Further, the side surface of the first insulating layer 3 composing the step-forming member 10 is composed of the slope, but the tilt angle is preferably set to be less than 90° with respect to the surface of the substrate 1 from a viewpoint of a manufacturing method, described later. The angle formed by the side surface of the second insulating layer 4 (see FIG. 8C) and the substrate 1 is not particularly limited as long as emission of the electrons from the protruding portion of the conductive film 6A is not prevented.

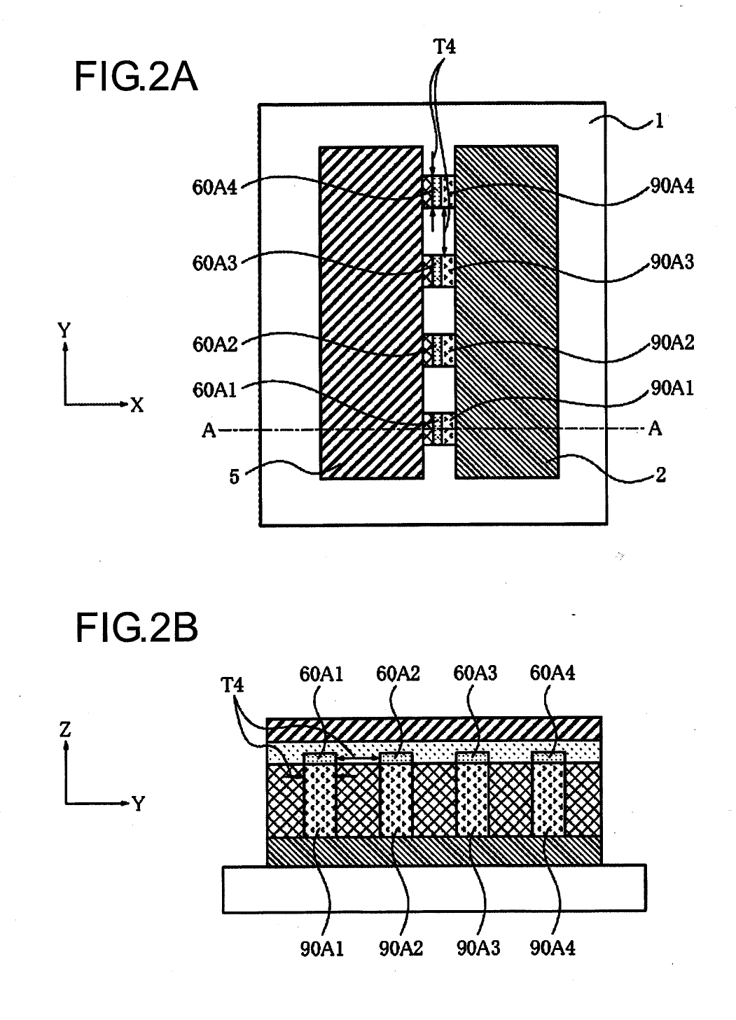

The electron-emitting device according to this embodiment can be constituted so that the conductive film (9A+6A) is divided into a plurality of reed-shaped pieces as shown in FIG. 2B.

In such a mode, a cross-sectional view taken along A-A line in FIG. 2A is similar to FIG. 1B. On the other hand, a plan view corresponding to FIG. 1A is like FIG. 2A, and a side view corresponding to FIG. 1C is like FIG. 2B. In FIG. 2A, the same members as those in FIG. 1A are denoted by the same reference symbols as those in FIG. 1A.

In FIGS. 2A and 2B, a plurality of reed-shaped resistive layers (90A1 to 90A4) is connected commonly to the electrode 2. The respective electron-emitting members (60A1 to 60A4) are connected to the electrode 2 via the corresponding resistive layers (90A1 to 90A4). In such a mode, when one electron-emitting member and one gate electrode are short-circuited and broken due to discharge or the like and thereby the electrons are not emitted from the broken one, the electron discharge from another electron-emitting member can be maintained.

The electron-emitting member 6A enters the recess portion as shown in FIG. 1B by a distance x from a boundary between the side surface of the step-forming member 10 and the recess portion 7 (the corner portion 32 of the first insulating layer 3). In other words, the electron-emitting member 6A contacts with the upper surface of the first insulating layer 3 in a direction of a depth (width) of the recess portion (minus X direction in FIG. 1B) by the distance x.

When the electron-emitting member 6A enters the recess portion 7 by the distance x, the following three advantages are derived.

(1) The electron-emitting member 6A to be the electron-emitting portion contacts with the first insulating layer 3 at a wide area, so that mechanical adhesion force is strengthened (rise in adhesion strength).

(2) A thermal contact area between the electron-emitting member 6A to be the electron-emitting portion and the first insulating layer 3 is widened, so that heat generated from the electron-emitting portion can be transferred to the first insulating layer 3 efficiently (reduction in thermal resistance).

(3) The side surface of the electron-emitting member 6A is inclined with respect to the upper surface of the first insulating layer 3, so that the strength of the electric field at a triple point of the insulating layer—the vacuum—the metal interface is weakened. As a result, a discharge phenomenon due to abnormal electric field can be prevented.

The distance x is a distance from the end portion of the electron-emitting member 6A in contact with the surface of the recess portion 7 to the edge of the recess portion 7. In other words, the distance x is a length by which the upper surface of the first insulating layer 3 and the conductive film 6A contact with a depth direction of the recess portion 7.

The resistive layer 9A (90A1 to 90A4) is described below.

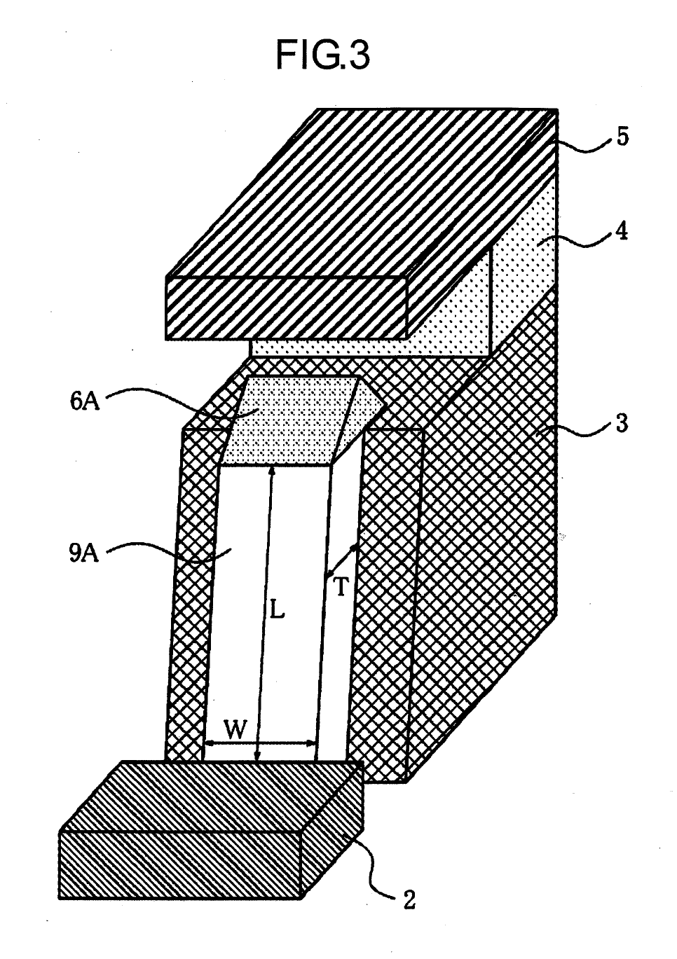

FIG. 3 is a schematic perspective view illustrating the electron-emitting device according to the embodiment, and L, T and W are scales for defining the shape of the resistive layer 9A. The other symbols denote the same members as those shown by the symbols used in FIGS. 1A, 1B and 2A. T is a film thickness of the resistive layer, L is a length of the resistive layer (the length from the electron-emitting member 6A to the cathode electrode 2), and W is a width of the resistive layer.

When the electron-emitting member 6A and the gate electrode 5 are short-circuited at a certain moment due to discharge and overcurrent flows, the resistive layer 9A (90A1 to 90A4) is fused instantly. As a result, a function for reducing damage of the electron-emitting device can be provided.

Such a function is effective particularly for the case where the plurality of resistive layers (90A1 to 90A4) is provided as shown in FIGS. 2A and 2B. This is because the resistive layer near a short-circuited portion is fused in one electron-emitting device, so that electron emission from the other electron-emitting member can be maintained. As a result, although an amount of electron emission from one electron-emitting device is reduced, inoperative of the electron-emitting device can be avoided. In the mode shown in FIG. 1A, when one electron-emitting device is short-circuited, the resistive layer 9A can prevent the other electron-emitting devices from being damaged and inoperative.

As causes of the short circuit, there are various causes such as discharge, residue in the recess portion 7, adhesion of impurities to a periphery of the recess portion 7, deformation of the gate electrode 5 due to heat caused by collision of emitted electrons with the gate electrode 5 extending in a canopy shape. A strong electric field of several dozens mega V/cm is generated between the gate electrode 5 and the electron-emitting member 6A during electron emission. For this reason, ionized impurities which fly or are adsorbed to a vicinity of the electron-emitting member 6A are attracted by a coulomb force, and are adsorbed between the electron-emitting member 6A and the gate electrode 5.

A mechanism which fuses the resistive layer 9A (90A1 to 90A4) at the time of the short circuit is mainly disappearance of a film due to Joule heat. A material composing the resistive layer is fused at the time of reaching the evaporation temperature at the pressure by generated Joule heat according to a relationship expressed by the following formula 1.

T=I²(Rτ)/(mc)=J²(ρτ)/(σc) (Formula 1)

In the formula 1, T: temperature, I: a current value of the overcurrent, R: resistance value of a film, τ: time of overcurrent, m: mass of a film, c: specific heat, J: current density of overcurrent, ρ: resistivity of a film, and σ: film density.

As is clear from the formula 1, the temperature T at the time of the flow of the overcurrent is proportional to the resistivity ρ and is inversely proportional to the density σ. The resistivity is inversely proportional to the density in a metal film or a semiconductor film. That is to say, the same material is used, as the film density is higher, the resistivity is lower. Further, it is known that a tilt of the resistivity with respect to the density becomes steep at film coating percentage of around 50% (document: Journal of Applied Physics 100 (2006) 113709).

When the film coating percentage is several %, a conductive wire mechanism made of an inter-island tunnel is used, and the resistivity is determined by a distance between island-shaped cores. The islands start to be eventually connected into a network shape at the coating percentage of around 50%, and the resistivity abruptly reduces. When the coating percentage exceeds 60%, a fluctuation range of the resistivity with respect to the coating percentage becomes small.

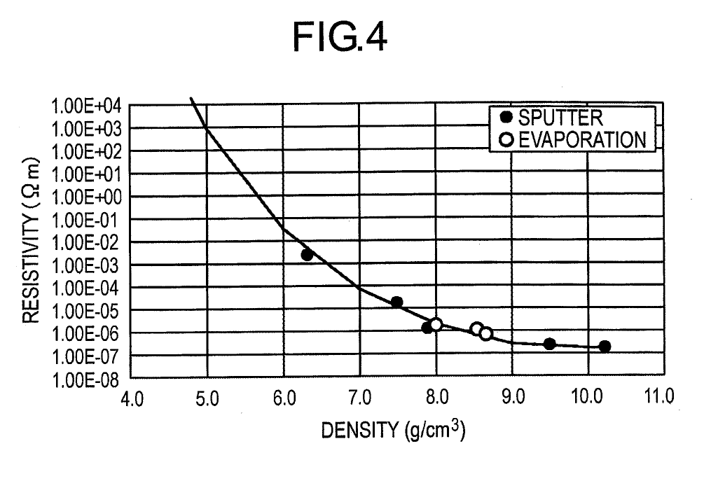

FIG. 4 illustrates a relationship between the film density (g/cm³) and the resistivity (Ωm) obtained in a molybdenum film deposited by a sputtering method or an evaporation method. For example, in the case of molybdenum, an abrupt tilt appears around the film density (5.14 g/cm³) corresponding to packing density of 50%. In the metal film or the semiconductor film, the resistivity is inversely proportional to the density.

When such a metal film and a semiconductor film are used as the resistive layer 9A (90A1 to 90A4), the film density of an area with the abrupt tilt easily causes variation of the resistivity, thereby causing variation of the electron emission characteristic. Therefore, the film density of the area where a tilt of the resistivity with respective to the film density is small is desirably used.

In FIG. 4, when the film density is 5.14 g/cm³, the resistivity is 31.1 Ωm, and when the film density is 6.0 g/cm³, the resistivity is 0.02 Ωm. Therefore, for example, L in FIG. 3 is set to 1000 nm, T is set to 5 nm and W is set to 4000 nm, namely, practical design values are set. In this case, when the film density of the resistive film 9A is 5.14 g/cm³, resistance per one electron-emitting device is 2 GΩ. On the other hand, when the film density of the resistive layer 9A is 6.0 g/cm³, the resistance per one electron-emitting device is 1 MΩ, and thus the resistance can be reduced by three digits in comparison with the case where the film density is 5.14 g/cm³. When the electron-emitting devices are driven so as to emit electrons, an electric current (device current: If) flows between the gate electrode 5 and the cathode electrode 2. When this electric current is assumed to be 1 μA which is a practically allowed value, a voltage drop in the resistive layer 9A becomes 2 kV when the film density is 5.14 g/cm³. When such a large voltage drop occurs, the electron-emitting device cannot be used as a practical device, but when the film density is 6.0 g/cm³, the voltage drop can be 1 V, and thus the electron emitting device can be served as a practical device. For this reason, it is preferable that the film density of the resistive layer 9A (90A1 to 90A4) is 6.0 g/cm³ or more.

The fusing mechanism of the resistive layer in the case where molybdenum is used as the materials of the resistive layer 9A (90A1 to 90A4) and the electron-emitting member 6A is described below.

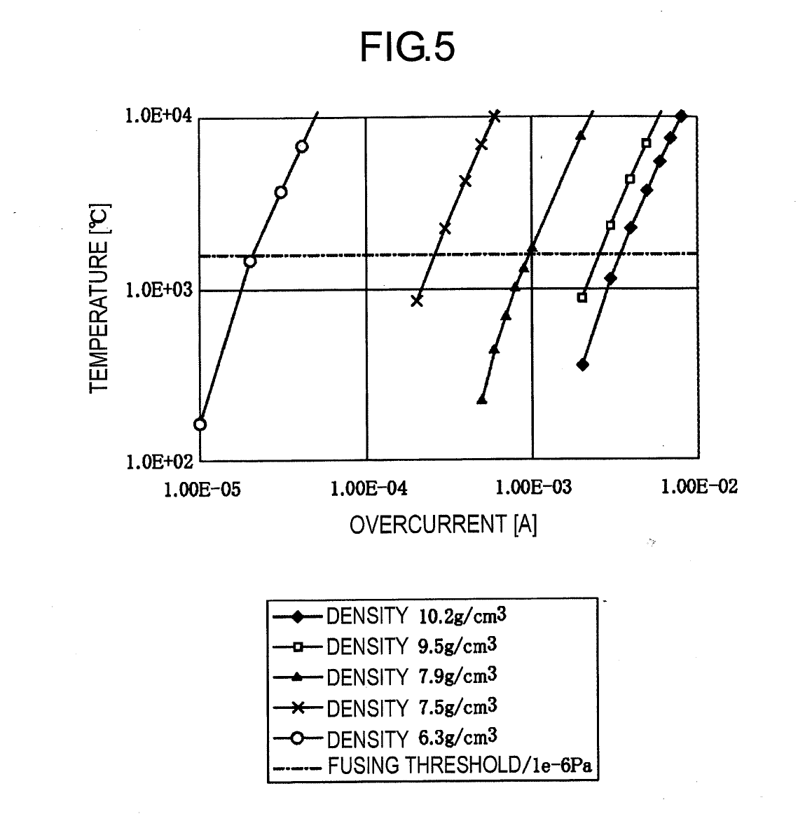

The specific heat of molybdenum is 0.25 J/gK. For example, when the shape of the resistive layer 9A and the time of the overcurrent are set as shown in Table 1, a proportional relationship between the value of the overcurrent and the temperature of the resistive layer is obtained as shown in FIG. 5 by using the formula 1.

TABLE 1

| | | |
|---|---|---|
| Length L: | 360 | nm |
| Film thickness T: | 5 | nm |
| Width W: | 4 | μm |
| Specific heat of molybdenum: | 0.25 | J/gK |
| Time of overcurrent: | 1 | μsec |

As the film density is reduced, a proportional curve further shifts to a left side. For example, the evaporation temperature of the molybdenum material at about 1×10⁻⁶ Pa which is vacuum of general FED (Field Emission Display) is 1600° C. Therefore, when the temperature of the resistive layer exceeds 1600° C., it is fused.

In FIG. 5, 1600° C. is shown by an alternate long and short dash line. When the temperature of the resistive layer exceeds the alternate long and short dash line in a temperature rise curve due to overcurrent, the resistive layer is fused.

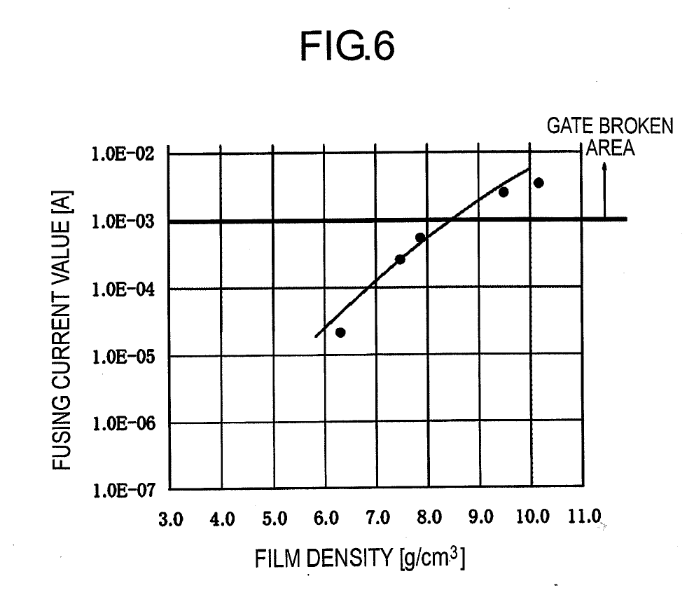

FIG. 6 illustrates a relationship between the film density and a current value for fusing calculated based on FIG. 5. Even when the resistive layers having the same shape are used, the film density is changed so that a current threshold for fusing can be defined.

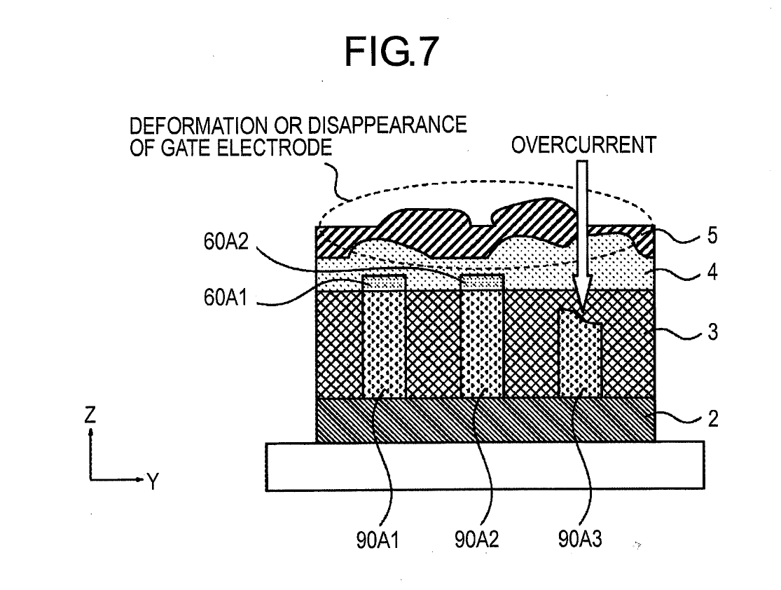

As the film density is reduced, the resistive layer is fused more easily, and thus a fusing effect can be easily displayed. On the other hand, when the film density is higher, an area where the current value for fusing becomes several mA which is high is present. When the current of several mA flows, the material of the gate electrode 5 is deformed or disappears as shown in FIG. 7, and thus electrons are not emitted from the other normal electron-emitting members 60A1 and 60A2.

According to the type and shape of the gate electrode, the current value is desirably 1 mA or less in order to use the gate electrode 5 stably. From the above viewpoint, the film density in the case where molybdenum is used as the material of the resistive layer is desirably 8.5 g/cm³ or less.

The film density of the resistive layer 9A (90A1 to 90A4) using molybdenum is desirably not less than 6.0 g/cm³ and not more than 8.5 g/cm³. The density (film density) of the electron-emitting member 6A (60A1 to 60A4) made of the same material as that of the resistive layer may be higher than the film density of the resistive layer. For this reason, the density (film density) of the electron-emitting member 6A (60A1 to 60A4) may be 8.6 g/cm³ or more and its upper limit is not particularly present. However, the density may be set to 10.3 g/cm³ or less practically. In consideration of stability, the density (film density) of the electron-emitting member 6A (60A1 to 60A4) is desirably 9.0 g/cm³ or more.

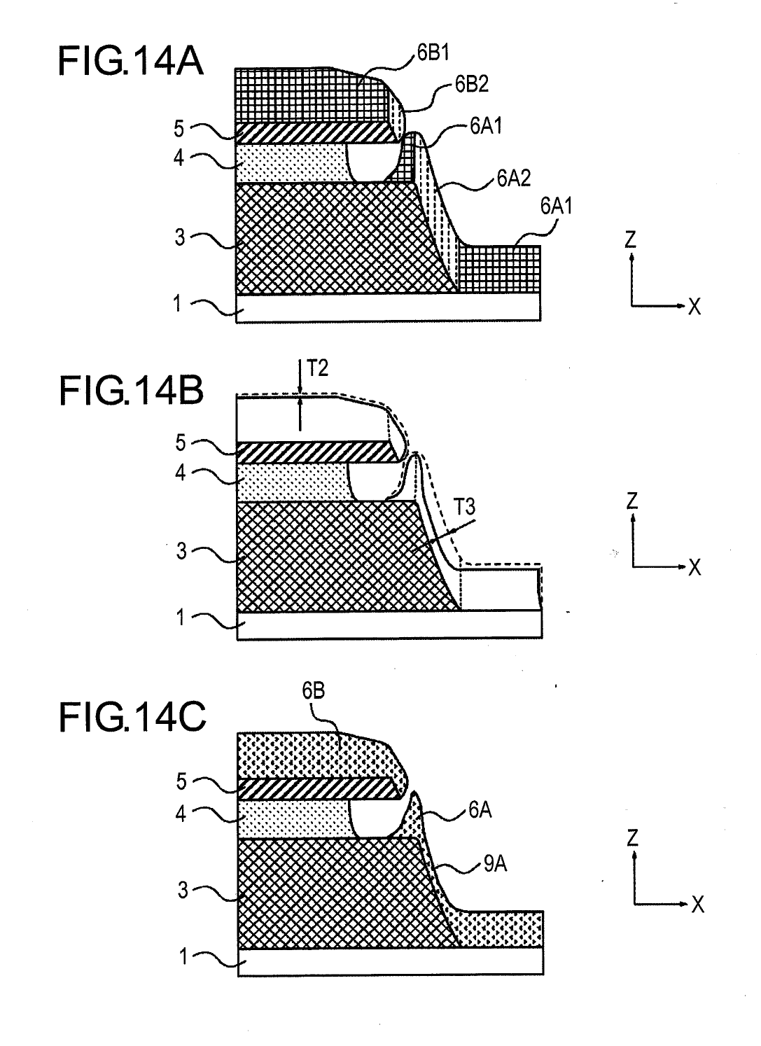

One example of a method of manufacturing the electron emitting device is described with reference to FIGS. 8A to 8G and 14A to 14C. FIGS. 8A to 8G are schematic diagrams illustrating manufacturing steps sequentially.

A series of steps in the manufacturing method according to the embodiment is described simply, and thereafter, the respective steps are detailed.

(Step 1)

An insulating layer 30 to be the first insulating layer 3 is formed on the surface of the substrate 1, and an insulating layer 40 to be the second insulating layer 4 is laminated on the upper surface of the insulating layer 30. A conductive layer 50 to be the gate electrode 5 is laminated on an upper surface of the insulating layer 40 (FIG. 8A). A material of the insulating layer 40 is selected differently from a material of the insulating layer 30 so that an amount of etching using an etching liquid (etchant) used at step 3, described later, on the insulating layer 40 becomes larger than that of the insulating layer 30.

(Step 2)

An etching process for the conductive layer 50, the insulating layer 40 and the insulating layer 30 (first etching process) is executed.

Specifically, the first etching process is a process for etching the conductive layer 50, the insulating layer 40 and the insulating layer 30 after forming a resist pattern on the conductive layer 50 by using a photolithography technique. At step 2, the first insulating layer 3 and the gate electrode 5 composing the electron-emitting device shown in FIG. 1B are formed basically (FIG. 8B). As shown in FIG. 8B, it is preferable that an angle (θ) formed by the side surface (slope) of the first insulating layer 3 formed at this step and the surface of the substrate 1 becomes smaller than 90°. Further, it is preferable that an angle formed by the side surface (slope) of the gate electrode 5 and the upper surface of the first insulating layer 3 (surface of the substrate 1) becomes smaller than the angle formed by side surface (slope) of the first insulating layer 3 and the surface of the substrate 1.

(Step 3)

Thereafter, an etching process (second etching process) is executed on the insulating layer 40 (FIG. 8C).

At step 3, the second insulating layer 4 forming the electron-emitting device shown in FIG. 1A is formed basically. As a result, the recess portion 7 composed of a part of the upper surface of the first insulating layer 3 and the side surface of the second insulating layer 4 is formed (FIG. 8C). Further, at step 3, since the side surface of the insulating layer 40 is etched, a part of the upper surface of the first insulating layer 3 is exposed. As a result, the corner portion 32 is exposed as a portion where the upper surface of the first insulating layer 3 and the slope to be the side surface of the first insulating layer 3 are connected.

(Step 4)

A peeling layer is formed on the gate electrode 5 (not shown).

The peeling layer is formed in order to peel the material to be deposited at step 5 from the gate electrode. For this object, the peeling layer is formed by a method of oxidizing the gate electrode to form an oxide film, or a method of depositing peeling metal is adhered by electrolytic plating.

The peeling layer is provided in order not to provide the conductive film (6B) on the gate electrode 5, but when the conductive film (6B) is provided onto the gate electrode 5, this step is omitted.

(Step 5)

The conductive film 60A made of the material composing the resistive layer 9A and the electron-emitting member 6A is deposited so as to cover the surface of the substrate 1 via the slope as the side surface of the first insulating layer 3 on the cathode electrode 2 side to the upper surface of the first insulating layer 3. That is to say, the conductive film 60A extends from the slope (side surface) of the first insulating layer 3 to the upper surface of the first insulating layer 3 so as to cover at least a part of the corner portion 32 of the first insulating layer 3. The conductive film 60A is preferably deposited so that its density of a portion on the corner portion 32 of the first insulating layer 3 (and the upper surface of the first insulating layer 3) becomes higher than that of a portion on the slope of the first insulating layer 3. The portion on the corner portion 32 of the first insulating layer 3 (and the upper surface of the first insulating layer 3) is a portion to be the electron-emitting member 6A. Further, the portion on the slope of the first insulating layer 3 is a portion to be the resistive layer 9A.

At the same time, a film 60B made of the material composing the conductive film (6B) can be deposited on the gate electrode 5.

In such a manner, the conductive film 60A (and 60B) is formed (FIG. 8D).

In an example shown in FIG. 8D, the conductive films 60A and 60B are deposited so as to contact with each other. Further, at step 5, the conductive films 60A and 60B can be deposited so as not to contact with each other, namely, so that a gap is formed.

However, in order to control a size (distance d) of the gap accurately, as shown in FIG. 8D, the conductive films 60A and 60B are desirably deposited so as to contact with each other. The details are described later.

(Step 6)

Thereafter, an etching process (third etching process) is executed on the conductive films (60A and 60B). The third etching process is a process which is mainly an etching process on the conductive films (60A and 60B) in a film thicknesswise direction. At step 6, the film thickness of the portion corresponding to the resistive layer 9A of the conductive film 60A is made to be thin, so that the resistive layer 9A is formed.

When the conductive films 60A and 60B are formed in a contact manner at step 5, the gap can be formed therebetween at step 6. At step 6, the end portion (protruding portion) of the conductive film 60A can be pointed. An unnecessary conductive material (the material composing the conductive films (60A and 60B)) which adheres into the recess portion can be removed.

As a result, the conductive films (9A and 6A) composed of the electron-emitting member 6A and the resistive layer 9A and the conductive film (6B) on the gate electrode 5 are formed (FIGS. 8E and 8F).

At step 6, an oxidizing process for oxidizing the surfaces of the conductive films (60A and 60B) is occasionally added before the etching process. Step 6 is occasionally a step at which the oxidizing process and the etching process are repeated.

When the oxidizing process and the etching process are executed, as shown in FIG. 8F, while a preferable shape of the electron-emitting member 6A is being maintained, controllability of an etching amount of the portion corresponding to the resistive layer 9A of the conductive film 60A increases in comparison with the case of a simple etching process (FIG. 8E). Further, the end of the protruding portion of the electron-emitting member 6A can be pointed with good controllability. The gap 8 between the conductive films 6A and 6B, or the conductive film 6A and the gate electrode 5 can be formed with good controllability.

As a result, the electron-emitting device which has higher electron emission efficiency and the resistive layer 9A can be obtained.

Step 6 is a process for etching the conductive films (60A and 60B) in the film thicknesswise direction. At step 6, all exposed surfaces of the conductive films (60A and 60B) are exposed to etchant.

(Step 7)

The peeling layer is removed by etching so that the conductive film 6B on the gate electrode 5 is removed (not shown).

When the peeling layer 12 is not formed at step 4 and the conductive film 6B is provided onto the gate electrode 5, this step is omitted.

(Step 8)

The cathode electrode 2 for supplying electrons to the electron-emitting member 6A is formed (FIG. 8G). This step can be transferred before or after the other steps.

Basically, the electron-emitting device shown in FIG. 1A can be formed at steps 1 to 8.

The respective steps can be described in more detail below.

(About Step 1)

The substrate 1 is a substrate which supports the electron-emitting device. As the substrate 1, quartz glass, glass where a contained amount of impurity such as Na is reduced, or soda-lime glass can be used. The functions necessary for the substrate 1 include not only high mechanical strength but also resistance properties against dry etching, wet etching, and alkali and acid of a developer or the like. When the substrate 1 is used for an image display apparatus, since it undergoes a heating step, the substrate 1 desirably has coefficient of thermal expansion is less different from that of a member to be laminated. In view of the thermal treatment, a material in which an alkaline element difficulty diffuses from the inside of the glass into the electron-emitting device is desirable.

The insulating layer 30 (first insulating layer 3) is made of a material with excellent workability, and its example includes silicon nitride (typically Si₃N₄) and silicon oxide (typically SiO₂). The insulating layer 30 can be formed by a general vacuum deposition method such as a sputtering method, a CVD (chemical vapor deposition) method, or a vacuum evaporation method. A thickness of the insulating layer 30 is set within a range of a several nm to several dozen μm, and preferably within a range of several dozen nm to several hundred nm.

The insulating layer 40 (second insulating layer 4) is made of a material with excellent workability, and this example includes silicon nitride (typically Si₃N₄) and silicon oxide (typically SiO₂). The insulating layer 40 can be formed by the general vacuum deposition method such as the sputtering method, the CVD method, or the vacuum evaporation method. A thickness of the insulating layer 40 is thinner than the insulating layer 30, and is set within a range of a several nm to several hundred nm, and preferably a several nm to several dozen nm.

After the insulating layers 30 and 40 are laminated on the substrate 1, the recess portion 7 should be formed at step 3. For this reason, in the second etching process, an etching amount on the insulating layer 40 is larger than that on the insulating layer 30. Desirably a ratio of the etching amount between the insulating layers 30 and 40 is 10 or more, and more preferably 50 or more.

In order to obtain such a ratio of the etching amount, the insulating layer 30 may be formed by a silicon nitride film, and the insulating layer 40 may be composed of a silicon oxide film, PSG whose phosphorus density is high or a BSG film whose boron density is high. PSG is phosphorus silicate glass, and BSG is boron silicate glass.

The conductive layer 50 (gate electrode 5) has conductivity, and is formed by the general vacuum deposition technique such as the evaporation method and the sputtering method.

A material of the conductive layer 50 to be the gate electrode 5 desirably has conductivity, high thermal conductivity, and high melt point. Metal such as Be, Mg, Ti, Zr, Hf, V, Nb, Ta, Mo, W, Al, Cu, Ni, Cr, Au, Pt or Pd, or a metal alloy material thereof can be used. Further, carbide, boride or nitride can be used, or semiconductor such as Si or Ge can be also used.

A thickness of the conductive layer 50 (gate electrode 5) is set within a range of a several nm to several hundred nm, and preferably within a range of several dozen nm to several hundred nm.

Since a film thickness of the conductive layer 50 to be the gate electrode 5 is occasionally set to be thinner than the cathode electrode 2, the conductive layer 50 is desirably made of a material with lower resistance than that of the cathode electrode 2.

(About Step 2)

The first etching process preferably uses RIE (Reactive Ion Etching) in which etching gas is converted into plasma and is emitted to the material, so that the material can be etched precisely.

When a member to be processed is made of a material for forming fluoride, fluorine gas such as CF₄, CHF₃ or SF₆ is selected as the gas used for RIE. When the member to be processed is made of a material forming chloride such as Si or Al, chlorine gas such as Cl₂ or BCl₃ is selected. In order to obtain a selected ratio with respect to resist and in order to secure smoothness on an etching surface or heighten an etching speed, at least any one of hydrogen, oxygen and argon gas is added to etching gas.

At step 2, the shapes which are the same as or the approximately same as the first insulating layer 3 and the gate electrode 5 composing the electron-emitting device shown in FIG. 1A are formed basically. However, it does not mean that the first insulating layer 3 and the gate electrode layer 5 are not etched entirely at the etching process after step 2.

An angle formed by the slope of the first insulating layer 3 and the surface of the substrate 1 (shown by θ in FIG. 8B) can be controlled to a desired value by controlling conditions such as types and pressure of gas. θ is preferably set to an angle (θ) smaller than 90°. This is because film quality (film density) of the conductive film 60A (conductive film 6A) to be formed on the slope of the first insulating layer 3 is controlled at step 5.

When θ is set to an angle smaller than 90°, the side surface of the gate electrode 5 on the cathode electrode side retreats further than the side surface of the first insulating layer 3 on the cathode electrode side. The angle formed by the side surface (slope) of the gate electrode 5 and the upper surface of the first insulating layer 3 (the surface of the substrate 1) is preferably set to be smaller than the angle formed by the side surface (slope) of the first insulating layer 3 and the surface of the substrate 1. An angle formed by the upper surface of the first insulating layer 3 and the side surface of the first insulating layer 3 can be regarded as 180°−θ. The angle θ can be expressed by an angle formed by a tangent line and the substrate 1 when the tangent line is drawn from the corner portion 32 (see FIG. 80) towards the substrate 1 on the side surface of the first insulating layer 3. Since the insulating layer 3 is formed on the surface of the substrate 1 by a deposition method to be generally used, the upper surface of the insulating layer 3 can be parallel (or substantially parallel) with the surface of the substrate 1 (horizontal direction 12). That is to say, the upper surface of the insulating layer 3 is occasionally parallel with the surface of the substrate 1 completely, but the upper surface normally has a slight tilt depending on deposition phenomenon and condition, but such a case is included within a range of parallel or substantially parallel.

(About Step 3)

At step 3, an etching liquid is selected so that an amount of etching the insulating layer 3 using the etching liquid is sufficiently smaller than an amount of etching the insulating layer 40 using the etching liquid.

At the second etching process, when the insulating layer 40 is formed by silicon oxide and the first insulating layer (insulating layer 30) is formed by silicon nitride, so-called buffered hydrogen fluoride (BHF) may be used as the etching liquid. The buffered hydrogen fluoride (BHF) is a mixed solution of ammonium fluoride and hydrofluoric acid. Further, when the insulating layer 40 is formed by silicon nitride and the first insulating layer 3 (insulating layer 30) is formed by silicon oxide, hot phosphoric acid etching liquid may be used as etchant.

At step 3, the pattern which is the same as or the approximately same as the second insulating layer 4 composing the electron-emitting device shown in FIG. 1A is formed. However, it does not mean that the second insulating layer 4 is not entirely etched at the etching process after step 3.

A depth of the recess portion 7 (distance in a widthwise direction) deeply relates to a leak current of the electron-emitting device. As the recess portion 7 is made to be deeper, the value of the leak current becomes smaller. However, when the recess portion 7 is too deep, a problem such that the gate electrode 5 is deformed arises. For this reason, the depth is practically set to not less than 30 nm and not more than 200 nm. The depth of the recess portion 7 can be put into a distance from the side surface of the insulating layer 3 (or the corner portion 32) to the side surface of the insulating layer 4.

(About Step 5)

At step 5, the conductive films (60A and 60B) are formed by the vacuum deposition technique such as the evaporation method and the sputtering method.

The conductive film 60A is preferably deposited so that the density of the portion on the corner portion 32 of the first insulating layer 3 (and the upper surface of the first insulating layer 3) becomes higher than that of the portion on the slope of the first insulating layer 3. With such deposition, the conductive film 60A can be constituted so that the end portion on the upper surface (corner portion 32) of the first insulating layer 3 has a protruding shape (protruding portion). That is to say, as shown in FIG. 8D, the conductive film 60A can be formed so that the pointed protruding portion is provided onto the upper surface of the first insulating layer 3 (corner portion 32). The conductive film 60A is formed so that the film density of the portion on the slope of the first insulating layer 3 is lower than the film density of the protruding portion of the conductive film 60A. As a result, the protruding portion can be further pointed by the third etching process at step 6. In the conductive film 60A, the protruding portion as the portion on the corner portion 32 of the first insulating layer 3 (and the upper surface of the first insulating layer 3) is a portion to be the electron-emitting member 6A. Further, in the conductive film 60A, the portion on the slope of the first insulating layer 3 is a portion to be the resistive layer 9A.

In order to perform such deposition, the conductive film 60A is deposited by a film forming method (film deposition method) having directional characteristic (directionality) For example, a so-called directional sputtering method or an evaporation method can be used. When the deposition method having directionality is used, an angle at which the material of the conductive films (60A and 60B) enters the upper surface and the side surface of the first insulating layer 3 (and the upper surface and the side surface of the gate electrode 5) can be controlled.

Specifically, in the directional sputtering, after the angle between the substrate 1 and a target is set, a shielding plate is provided between the substrate 1 and the target, or a distance between the substrate 1 and the target is set to around a mean free path of the sputtered particles. A so-called collimation sputtering method using a collimator for giving directionality to the sputtered particles is also included in the directional sputtering method. Only the sputtered particles (atoms or particles which are sputtered) at the limited angle can enter the surface to be deposited (the slope of the insulating layer 30 or the like).

That is to say, an incidence angle of the sputtered particles with respect to the slope of the first insulating layer 3 (an angle formed by an incident direction of the sputtered particles and a normal line of the slope of the first insulating layer 3) may be made to be larger than an incidence angle of the sputtered particles with respect to the upper surface (corner portion 32) of the first insulating layer 3 (the angle formed by the incident direction of the sputtered particles and the normal line of the upper surface of the first insulating layer 3). In other words, the angle formed by the incident direction of the sputtered particles and the upper surface (corner portion 32) of the first insulating layer 3 is set to be closer to 90° than the angle formed by the incident direction of the sputtered particles and the slope of the first insulating layer 3. As a result, the sputtered particles enter the upper surface (corner portion 32) of the first insulating layer 3 in a state closer to a vertical state than the slope of the first insulating layer 3. With such deposition, the end portion on the upper surface (corner portion 32) of the first insulating layer 3 of the conductive layer 60A can be provided with a protruding shape (protruding portion).

In the evaporation method, when a film is deposited under high vacuum of about 10⁻² to 10⁻⁴ Pa, a vaporized material (deposition material) evaporated from an evaporation source less likely collides. Further, since the mean free path of the vaporized material (deposition material) is about several hundred mm to a several m, the vaporized material reaches the substrate with maintaining directionality at the time of evaporating from the evaporation source. For this reason, the evaporation method is a deposition method having directionality. The method of evaporating the evaporation source includes resistance heating, high-frequency induction heating and electron beam heating. The method using electron beams is effective from viewpoints of types of suitable materials and a heating area.

When θ is set to be smaller than 90° at step 2, the side surface of the gate electrode 5 on the cathode electrode 2 side retreats with respect to the side surface of the first insulating layer 3 on the cathode electrode 2 side as described above. As a result, the deposition having directionality at this step is carried out, a film is formed on the corner portion 32 so as to have a better quality than that on the side surface (slope). The “film with good quality” can be a “film with high density” or a “film with high film density”.

Therefore, when the angle θ formed by the first etching process at step 2 is set to be smaller value, more films with good quality can be formed on the upper surface of the first insulating layer 3. That is to say, when the retreating amount of the side surface of the gate electrode 5 on the cathode electrode 2 side with respect to the side surface of the first insulating layer 3 on the cathode electrode 2 side is increased, more films with good quality can be formed on the upper surface of the first insulating layer 3.

At this step, the conductive film 60A and the conductive film 60B can be deposited so as not to contact with each other, namely, so that a gap is formed therebetween. Further, when the conductive film 6B is not provided onto the gate electrode 5, the conductive film 60A is deposited so as to be separated from the gate electrode 5.

In the electron-emitting device, the gap as the distance d should be formed precisely between the electron-emitting member 6A and the gate electrode 5 (conductive film 6B) Particularly when a plurality of electron-emitting devices is formed uniformly, it is important that dispersion of the size of the gaps in the electron-emitting devices is reduced. In order to precisely control the size (distance d) of the gap, the conductive films 60A and 60B are desirably deposited so as to contact with each other at step 5. In other words, the conductive film 60A and the gate electrode 5 are desirably deposited so as to be connected via the conductive film 60B at step 5. Thereafter, the third etching process is executed at step 6 so that the gap is desirably formed between the conductive films 60A and 60B. When the gap is formed by controlling deposition time and deposition condition at step 5, a portion where the conductive films 60A ad 60B contact at a very small area (leak source) is likely formed in any place of the recess portion 7. For this reason, after step 5, the third etching process at step 6 should be executed.

The conductive films 60A and 6013 may be made of the same material or different materials. However, the conductive films 60A and 60B are preferably deposited by the same material simultaneously from viewpoints of easiness of the manufacturing and the controllability of etching.

The material of the conductive films (60A and 60B) may be a conductive and field emission material, and preferably a material with high melt point of 2000° C. or more is selected. The material of the conductive film 60A is a material with low work function of 5 eV or less, and preferably a material of which oxide can be easily etched. Examples of the material include metal such as Hf, V, Nb, Ta, Mo, W, Au, Pt or Pd, metal alloy, carbide, boride and nitride thereof. At step 6, a process for etching a surface oxide film using a difference in an etching property between the metal and the metal oxide is occasionally executed, Mo or W is preferably used as the material of the conductive films (60A and 60B).

(About Step 6)

As the third etching process, any one of dry etching and wet etching may be used, but the wet etching is preferable in view of ease of controlling an etching selection ratio with respect to another material.

When the material of the conductive films (60A and 60B) is molybdenum, an alkaline solution such as TMAH (tetramethylammonium hydroxide) can be used as an etching liquid.

Since the etching amount is as very small as about a several nm, the etching rate is desirably 1 or less nm per 1 minute from a viewpoint of stability. The etching rate means a film thickness variation per unit time. A number of atoms removed by the etching process per unit time is determined by the material of the conductive films (60A and 605) and the etching liquid uniquely. For this reason, the film density is inversely proportional to the etching rate. That is to say, as the film density is higher, the etching rate becomes lower.

The forming process of the resistive layer 9A, the formation of the gap and the pointing of the end portion (protruding portion) of the conductive film 60A by means of the third etching process are described with reference to FIGS. 14A, 145 and 140.

FIG. 14A illustrates a state that the conductive films (60A and 605) are deposited by the deposition method having directionality at step 5. The sputtered particles collide with the surface of the gate electrode 5, the surface of the substrate 1, the corner portion 32 of the first insulating layer 3 and the upper surface of the first insulating layer 3 at an angle close to 90° (an angle formed by a flying direction of the sputtered particles and the surfaces) by the sputtering method having directionality. The sputtered particles are particles sputtered from a sputtering target. For this reason, a good-quality film (expressed as “film with high density” or “film with high film density”) is formed on the above portions.

On the other hand, since the sputtered particles collide with the slope of the first insulating layer 3 and the surface of the gate electrode 5 near the end portion at a shallow angle (the angle separated from 90°), a film with low density (or “the film with low film density”) is formed on these surfaces.

In FIG. 14A, portions typically shown by 6A1 and 6B1 are the films with high density, and portions typically shown by 6A2 and 6B2 are the films with low density.

The film density is inversely proportional to an etching rate. For this reason, in the third etching process, the portions of the conductive films typically shown by 6A2 and 6B2 have higher etching rate than that of the portions of the conductive films typically shown by 6A1 and 6B1. At step 6, the entire exposed surfaces of the conductive films are exposed to etchant (are etched).

FIGS. 14B and 14C illustrate states that the third etching process is executed. In the drawings, T2 shows a reduction amount of the film thickness of the portion of a high-density film in the third etching process, and T3 shows a reduction amount of the film thickness of the portion of a low-density film in the third etching process. In this embodiment, a relationship such that T2<T3 holds. The reduction amount of the film thickness in the third etching process can be adjusted by etching time or the number of etching times. Since the relationship such that T2<T3, the thinning (forming a resistive film) of the portion on the side surface of the insulating layer 3 of the conductive film 60A proceeds by repeatedly executing the etching process, and simultaneously the pointing of the end portion (protruding portion) of the conductive film 60A is accelerated (FIG. 14C).

When the material of the conductive films (60A and 60B) is molybdenum, the density of the high-density film is desirably not less than 9.0 g/cm³ and not more than 10.3 g/cm³, and the density of the low-density film is desirably not less than 6.0 g/cm³ and not more than 8.5 g/cm³.

The above values fall within a practical range after the resistivity and the film thickness of the films and a difference in the etching rate are taken into consideration.

In general XRR (X-ray reflectometry) is used for measurement of the film density, but the measurement occasionally becomes difficult in the actual electron-emitting device. In this case, the following method can be adopted as the film density measuring method. For example, a standard curve is obtained by quantitatively analyzing elements of the film using a high-resolution electron energy loss spectroscopy TEM in which TEM (transmission electron microscope) and EELS (electron energy-loss spectroscope) and comparing the result with that of a known film. The density can be calculated using the standard curve.

A combination of the material of the conductive films (60A and 60B) and the etchant to be used for the third etching process in the present invention is not particularly limited. When the material of the conductive films (60A and 60B) is molybdenum, an alkaline solution such as TMAH (tetramethylammonium hydroxide) and ammonia water can be used as the etchant. A blended material of 2-(2-n-butoxyethoxy) ethanol and alkanolamine or DMSO (dimethylsulfoxide) can be used as the etchant.

When the material of the conductive films (60A and 60B) is tungsten, nitric acid, fluorinated acid, and sodium hydroxide solution can be used as the etchant.

Step 6 is composed of the oxidizing step of oxidizing the surfaces of the conductive films (60A and 60B) and the etching process for etching the surfaces of the oxidized conductive films (60A and 60B). After an oxide film of a desired amount is formed on the surfaces of the conductive films (60A and 60B) at the oxidizing step, the oxide film is etched to be removed. As a result, an effect which heightens uniformity (reproducibility) of the etching amount can be expected.

The oxidizing amount (oxide film thickness) is inversely proportional to the film density. That is to say, the oxidizing amount (oxide film thickness) of the surface of the portion whose film density is high becomes smaller than the oxidizing amount (oxide film thickness) of the surface of the portion whose film density is low. For this reason, when the conductive films (60A and 60B) are oxidized, the surface layer on the portion whose film density is low (portions 6A2, 6B2 in FIG. 14A) is oxidized preferentially (selectively). That is to say, when the oxidizing process and the etching process are executed, control accuracy of the film thinning (forming the resistive layer) on the side surface of the insulating layer 3 of the conductive film 60A and the pointing of the end portion (electron-emitting member) of the conductive film 60A can be heightened. Further, control accuracy of the distance of the gap can be heightened.

The oxidizing method is not particularly limited as long as the surface of the conductive film 60A can be oxidized by a several to several dozen nm. Specifically, the oxidizing method includes ozone oxidation (excimer UV exposure, low-pressure mercury exposure and corona discharge treatment) or thermal oxidation, but preferably the excimer UV exposure where quantitative property of oxidation is excellent is used. When the material of the conductive film 60A is molybdenum, MoO₃ in which the oxide film can be removed easily is mainly created by excimer UV exposure.

Any one of dry and wet etching processes may be used at the step of removing the oxide film, but the wet etching process is used preferably. The step of removing the oxide film (etching step) is for removing (etching) only the oxide film as the surface layer. For this reason, etchant which removes only the oxide film and does not substantially influence a metal layer (non-oxidized layer) as the lower layer is desired. Or it is desired that the etching rate of the oxide film is sufficiently larger (different order of magnitude) than that of the metal film (non-oxidized layer). Specifically, when the material of the conductive film (60A, 60B) is molybdenum, examples of the etchant are diluted TMAH (density is desirably 0.238% or less) and warm water (desirably 40° C. or more). When the material of the conductive film 60A is tungsten, buffered hydrogen fluoride, diluted hydrochloric acid and warm water can be used.

At step 6, the electron-emitting member 6A, the resistive layer 9A and the conductive film 6B are formed. The conductive film 6B is provided onto the gate electrode 5 (concretely, the side surface (slope) and the upper surface of the gate electrode). When the conductive film 6B is not provided, the electrons field-emitted from the end of the electron-emitting member 6A collide with the gate electrode 5 at first. For this reason, when the conductive film 6B (the portion on the side surface of the gate electrode 5) is not peeled to remain, it can be a portion with which the electrons emitted from the end of the protruding portion of the conductive film 6A firstly collide. For this reason, even when the melt point of the material composing the gate electrode 5 is slightly low, the conductive film 6B is formed by a material with high conductivity and high melt point (for example, molybdenum or tungsten) so that a deterioration of the electron emission characteristic of the electron-emitting device can be suppressed.

(About Step 8)

The cathode electrode 2 has conductivity similarly to the gate electrode 5, and can be formed by the general vacuum deposition technique such as the evaporation method and the sputtering method, and the photolithography technique. The material of the cathode electrode 2 may be the same as or different from that of the gate electrode 5.

The thickness of the cathode electrode 2 is set within a range of several dozen nm to a several μm, and preferably within a range of several hundred nm to a several μm.

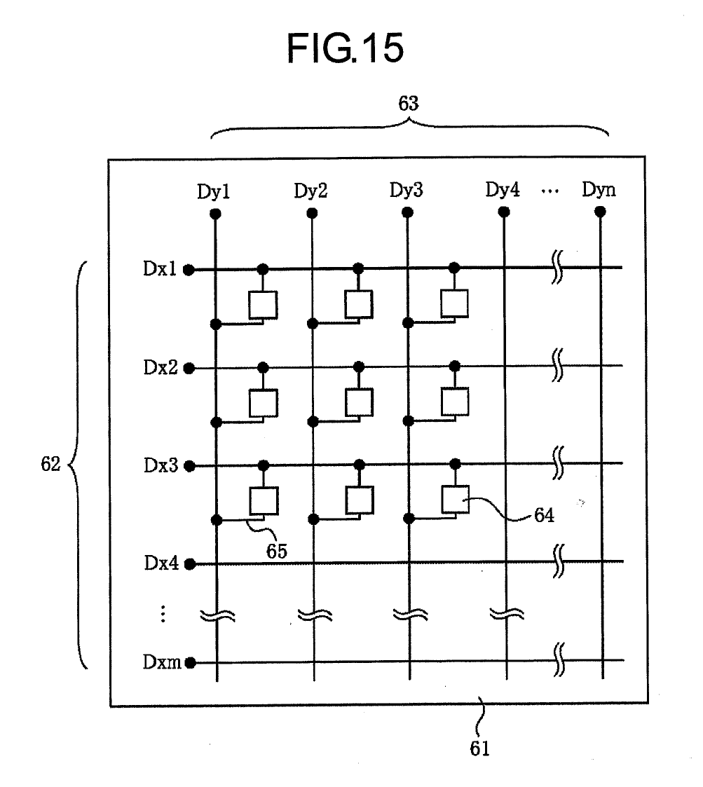

The image display apparatus having an electron source obtained by arranging the plurality of electron-emitting devices is described below with reference to FIGS. 15 to 17.

In FIG. 15, reference numeral 61 is a substrate, 62 is an X-direction wiring, and 63 is a Y-direction wiring. Reference numeral 64 is the electron-emitting device, and 65 is wire connection. The X-direction wiring 62 is a wiring connected to the cathode electrodes 2 commonly, and the Y-direction wiring 63 is a wiring connected to the gate electrodes 5 commonly.

The m-numbered X-direction wirings 62 are composed of DX1, DX2, . . . DXm, and can be composed of a conductive material such as metal formed by the vacuum evaporation method, a printing method or the sputtering method. The material, a thickness and a width of the wirings are suitably designed.

The n-numbered Y-direction wirings 63 are composed of DY1, DY2, . . . DYn, and are formed similarly to the X-direction wirings 62. An interlayer insulating layer, not shown, is provided between the m-numbered X-direction wirings 62 and the n-numbered Y-direction wirings 63, and they are electrically separated (m and n are positive integers).

The interlayer insulating layer, not shown, is formed by using the vacuum evaporation method, the printing method or the sputtering method. The interlayer insulating layer is formed into a desired shape on whole or part of the surface of the substrate 61 formed with the X-direction wirings 62. The thickness, the material and the manufacturing method are suitably set as to be capable of withstanding particularly a potential difference on a cross portion between the X-direction wirings 62 and the Y-direction wirings 63. The X-direction wirings 62 and the Y-direction wirings 63 are drawn as external terminals.

As to the materials composing the wirings 62 and 63, the material composing the wire connection 65, and the materials composing the cathode and the gate, some or all of their constituent elements may be the same or different.

A scan signal application unit, not shown, which applies a scan signal for selecting a row of the electron-emitting devices 64 arranged in the X direction is connected to the X direction wirings 62. On the other hand, a modulation signal generating unit, not shown, which generates modulation signals to be supplied to the electron-emitting devices 64 on the respective rows according to an input signal is connected to the Y direction wirings 63.

The drive voltage to be applied to each electron-emitting device is supplied as a difference voltage of the scan signal and the modulation signal applied to the device.

In the above constitution, the individual devices are selected by using a simple matrix wiring so as to be capable of being driven individually.

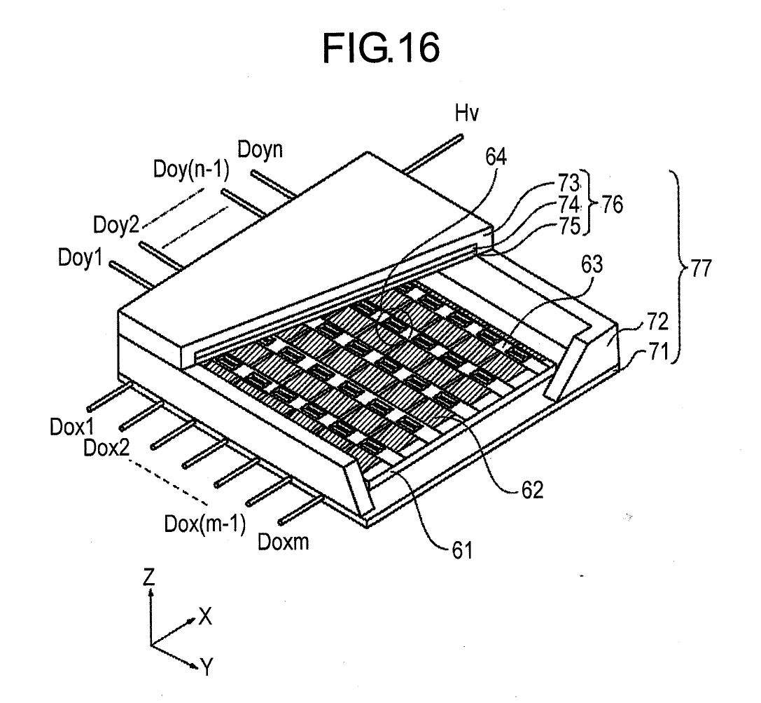

The image display apparatus constituted by using the electron source of the simple matrix arrangement is described with reference to FIG. 16. FIG. 16 is a diagram illustrating one example of an image display panel 77 of the image display apparatus.

In FIG. 16, reference numeral 61 is a substrate where a plurality of electron-emitting devices is arranged, and 71 is a rear plate which fixes the substrate 61. Reference numeral 76 is a face plate where a metal back 75 as an anode and a fluorescent substrate film as a film 74 of a light-emitting member are formed on an inner surface of a glass substrate 73.

Reference numeral 72 is a supporting frame, and the roar plate 71 and the face plate 76 are sealed (bonded) into the supporting frame 72 by using a bonding material such as frit glass. Reference numeral 77 is an envelope, and it is formed by calcining for 10 or more minutes within a temperature range of 400 to 500° C. in air or nitrogen and sealing.

Further, reference numeral 64 corresponds to the electron-emitting device in FIG. 1A, and 62 and 63 are the X direction wirings and the Y direction wirings which are connected to the cathode electrodes 2 and the gate electrodes 5 of the electron-emitting devices, respectively. FIG. 16 schematically illustrates a positional relation ship between the electron-emitting devices 64 and the wirings 62 and 63. Actually, the electron-emitting devices 64 are arranged on the substrate beside the cross portions between the wirings 62 and 63.

The image display panel 77 is composed of the face plate 76, the supporting frame 72 and the rear plate 71. Since the rear plate 71 is provided in order to mainly heighten the strength of the substrate 61, when the substrate 61 itself has sufficient strength, the rear plate 71 is unnecessary.

That is to say, the supporting frame 72 is sealed directly to the substrate 61, and the supporting frame and the face plate 76 may be sealed so as to compose the envelope 77. Further, a supporter, not shown, which is called as a spacer may be provided between the face plate 76 and the rear plate 71 to obtain the image display panel 77 having sufficient strength against atmosphere pressure.

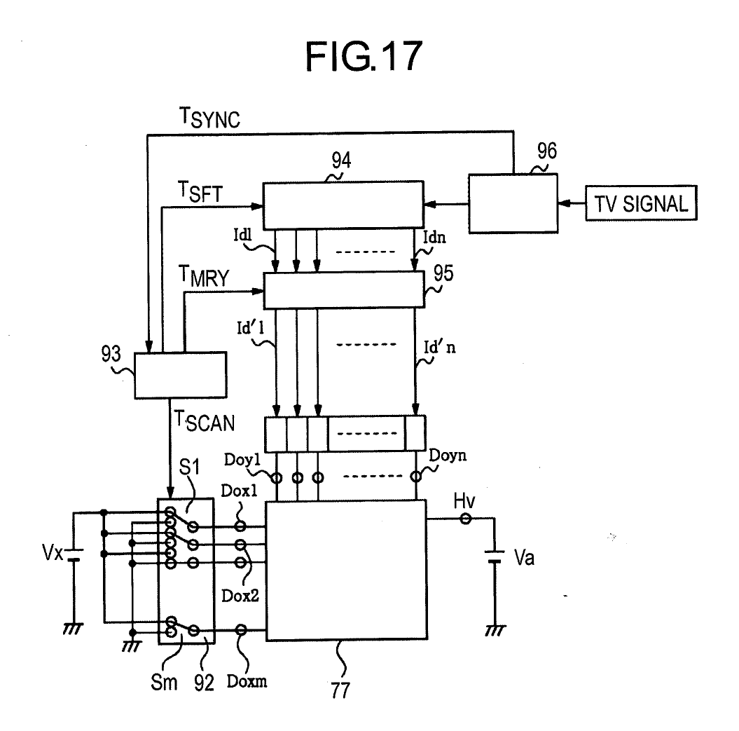

A configuration example of the drive circuit for television display based on a television signal on the image display panel 77 is described below with reference FIG. 17.

In FIG. 17, reference numeral 77 is the image display panel, 92 is a scan circuit, 93 is a control circuit, and 94 is a shift register. Reference numeral 95 is a line memory, 96 is a synchronous signal separating circuit, 97 is a modulation signal generator, and Vx and Va are DC current voltage sources.

The display panel 77 is connected to an external electric circuit via terminals Dox1 to Doxm, terminals Doy1 to Doyn, and a high-voltage terminal Hv.

A scan signal is applied to the terminals Dox1 to Doxm. The scan signal drives the electron source provided in the display panel 77, namely, the electron-emitting devices arranged into a matrix pattern and into m rows x n columns line by line (per N devices).

On the other hand, a modulation signal for controlling the output electron beams of the respective electron-emitting devices on one row selected by the scan signal is applied to the terminals Doy1 to Doyn.

A DC voltage of 10 [kV] is supplied to the high-voltage terminal Hv by the DC voltage source Va.

The emitted electrons are accelerated by the scan signal, the modulation signal and the high-voltage application to the anode to irradiate the fluorescence substance, so that an image is displayed.

### EXAMPLES

More detailed examples are described below.

### Example 1

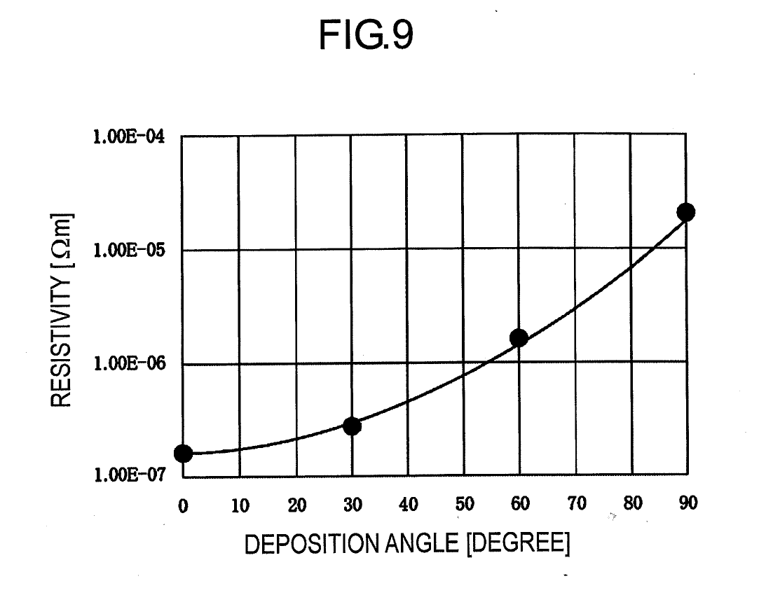

FIG. 9 shows a relationship between a film deposition angle (an angle formed by the target and the substrate surface) and the resistivity in the case where the angle of the substrate surface with respect to the target is changed from 0° (horizontal with the target) to 90° (vertical to the target) when molybdenum is sputter-deposited on the insulating substrate. After the films were deposited into 80 nm at the angles of 0°, 30°, 60° and 90° respectively, the films were etched by TMAH until the film thickness became 20 nm. Thereafter, the resistivity was measured. The resistivity was calculated by calculating sheet resistance according to a four probe method and dividing the sheet resistance by the film thickness. The resistivity rises in proportional to the deposition angle, and thus it is found that the film density can be controlled by the deposition angle. The deposition angle in the directional sputtering method (the angle formed by the target and the substrate surface) can be regarded as being equal to the incidence angle of the sputtered particles with respect to the substrate surface (the angle formed by the flying direction of the sputtered particles and the normal line of the substrate surface).

### Example 2

A method of manufacturing the electron-emitting device in the example 2 is described with reference to FIGS. 8A to 8G.

At first, the insulating layers 30 and 40 and the conductive layer 50 were laminated on the substrate 1 as shown in FIG. 8A.

Low-sodium glass PD200 was used as the substrate 1. The insulating layer 30 was formed by an SiN film according to the sputtering method so as to have a thickness of 500 nm. The insulating layer 40 was formed by an SiO₂ film according to the sputtering method so as to have a thickness of 30 nm. The conductive layer 50 to be the gate electrode 5 was composed of a TaN film, and was formed by the sputtering method into a thickness of 30 nm.

After a resist pattern was formed on the conductive layer 50 by the photolithography technique, the conductive layer 50, the insulating layer 40 and the insulating layer 30 were etched sequentially by using the dry etching method (FIG. 8B). As a result, the first insulating layer 3 and the gate electrode 5 were patterned. As etching gas at this time, CF₄ type gas was used for the insulating layers 30 and 40 and the conductive layer 50 because a material for forming fluoride was selected.

After the resist was peeled, the insulating layer 40 was etched by using BHF so that the depth of the recess portion 7 became about 70 nm, so that the recess portion 7 was formed on the step-forming member 10 composed of the insulating layers 3 and 4 (FIG. 8C). As a result, the second insulating layer 4 was patterned.

At this time, the angle θ of the side surface (slope) of the insulating layer 3 with respect to the horizontal surface (surface) of the substrate 1 was about 80°. Further, the angle of the upper surface of the insulating layer 3 with respect to the horizontal surface (surface) of the substrate 1 was about 0°.

Ni was electrolytically deposited on the gate electrode 5 by electrolytic plating so that a peeling layer made of Ni was formed.

As shown in FIG. 8D, molybdenum (Mo) was deposited on the side surface and the upper surface of the insulating layer 3 and on the gate electrode 5 (on the peeling layer) by the sputtering method so that the conductive films 60A and 60B contacted with each other.

Sputtering was determined so that the deposition speed on the surface of the substrate 1 became about 100 nm/min. The deposition time was precisely controlled (in this example, 0.7 minute), so that molybdenum of 70 nm was formed on the surface of the substrate 1 parallel with the target and molybdenum of 40 nm was formed on the side surface of the insulating layer 3 and the side surface of the gate electrode.

At this time, an entering amount (x) of the conductive film 60A into the recess portion 7 was set to 35 nm.

The conductive films (60A and 60B) were etched by using TMAH as etchant so that the gap 8 was formed, and the electron-emitting member 6A and the resistive member 9A were formed (FIGS. 8E and 8F).

The density of TMAH was adjusted so that an etching speed using TMAH was 0.2 nm/min on the surface of the substrate 1 and 0.6 nm/min on the side surface of the insulating layer.

In this example, the etching time (in this example, 50 minutes) was controlled precisely so that an MO film on the surface of the substrate 1 parallel with the target had a thickness of 60 nm. At this time, a thickness of Mo on the side surface of the insulating layer 3 was 10 nm.

The Ni peeling layer provided onto the gate electrode 5 was removed by an etching liquid composed of iodine and potassium iodide so that the conductive film 6B on the gate electrode was peeled.

Thereafter, the resist pattern was formed on the conductive film (electron-emitting member 6A and the resistive layer 9A) by a photolithography technique so that a width T4 (see FIG. 1A) of the conductive film (the electron-emitting member 6A and the resistive layer 9A) became 3 μm. Thereafter, the conductive film (the electron-emitting member 6A and the resistive layer 9A) was patterned by dry etching. As etching gas at this time, CF₄ type gas was used because molybdenum was a material for forming fluoride.

As a result of the analysis using a cross-section TEM, the shortest distances 8 between the end of the electron-emitting member 6A as the electron-emitting portion and the gate electrode 5 is 9 nm.

As shown in FIG. 8G, the cathode electrode 2 was formed. Copper (Cu) was used for the electrode 2. Its forming method was the sputtering method, and its thickness was 500 nm.

The resistive member 9A and the cathode 6A of the electron-emitting device formed by the above method were subject to TEM (transmission electron microscope) and EELS (electron energy-loss spectroscope) analyses so that the film density was calculated. As a result, the film density of the resistive layer 9A was 7.7 g/cm³ and the film density of the electron-emitting member 6A was 10.2 g/cm³.

In an image display apparatus using the electron-emission devices manufactured in this example, formability of an electron beam was excellent. Further, a display apparatus with good display image was realized, and the image display apparatus with high reliability without defective pixel due to discharge was provided. Further, when discharge was intentionally generated during the driving of the image display apparatus, it was confirmed that the resistive layer 9A composing one electron-emitting device was fused. However, the other electron-emitting devices were not broken.

### Example 3

In this example, two electron-emitting devices A and B were manufactured. Since the basic method of manufacturing the electron-emitting devices A and B is similar to that in the example 2, only different portions from the example 2 are described with reference to FIGS. 8A to 8G.

In order to make verification of a difference between the electron-emitting devices A and B easy, the film thickness of the insulating layer 3 in both the electron-emitting devices was 10 μm.

The other parts of the constitution excluding the film thickness of the insulating layer 3 in the electron-emitting device A were the same as those in the example 2.

On the other hand, the electron-emitting device B was formed at step shown in FIG. 8D so that the film thickness of Mo on the portion on the side surface of the insulating layer 3 in the conductive film 60A (low-density film: 6A2 in FIG. 14A) became 30 nm.

Next, a surface layer of molybdenum was oxidized. An EUV exposing method in ozone was used as the oxidizing method. An oxidizing speed was 2 nm/min on a portion parallel with the surface of the substrate 1 (high-density film: 6A1 in FIG. 14A), and 4 nm/min on a portion on the side surface of the insulating layer 3 (low-density film: 6A2 in FIG. 14A). On the portion parallel with the surface of the substrate 1 (high-density film), time was controlled precisely so that the film thickness of the oxide layer to be formed became 10 nm (in this example, 5 min). At this time, the film thickness of the oxide layer formed on the surface of the portion on the side surface of the insulating layer 3 of the conductive film 60A was 20 nm.

In order to remove the oxide layer, the oxide layer was dipped in warm water of 45° C. so as to be subject to the etching process. The etching speed of the oxide layer was 0.5 nm/min, and the oxide layer was etched until its film thickness on the side surface became 5 nm (in this example, 30 min). In such a manner, the thickness of Mo on the side surface of the insulating layer 3 and the side surface of the gate electrode 5 was 10 nm, and the film thickness of the oxide layer provided on its surface was 5 nm. The thickness of Mo on the portion parallel with the surface of the substrate 1 (on the upper surface of the insulating layer 3 and the upper surface of the gate electrode 5) was 42 nm. Further, the electron-emitting device B was formed so that the entering amount (x) of the electron-emitting member 6A into the recess portion 7 was 35 nm, and an angle at which the upper surface of the insulating layer 3 in the recess portion 7 contacts with the side surface of the electron-emitting member 6A was 120°.

A heating step was executed at 450° C. for one hour in vacuum.

The other parts of the forming method and the constitution of the electron-emitting device B were the same as those in the example 2.

A difference from the electron-emitting device A was that the resistive layer 9A of the electron-emitting device B was composed of a molybdenum layer with thickness of 10 nm and a molybdenum oxide layer with thickness of 5 nm was provided on the surface of the molybdenum layer.

A method of evaluating electric characteristics of the electron-emitting devices A and B is described below. The electron-emitting device A had the resistive layer 9A composed of the molybdenum layer. The electron-emitting device B had the resistive layer 9A composed of a laminated member including the molybdenum oxide layer and the molybdenum layer.

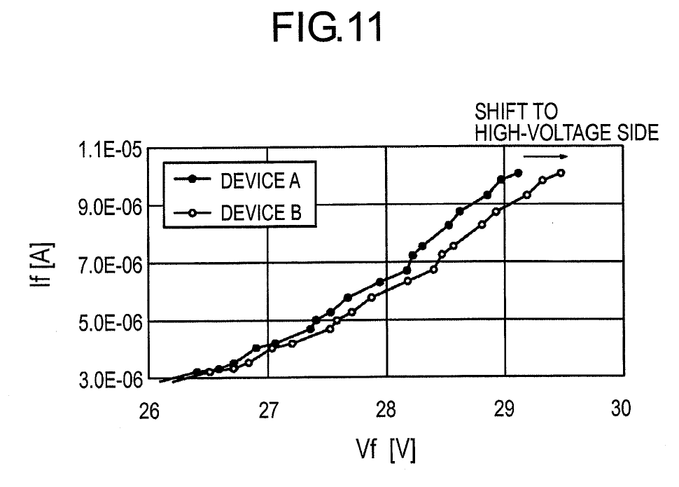

In FIG. 11, voltage-current curves of the electron-emitting device A and the electron-emitting device B are compared. The electron-emitting device A had the resistive layer 9A formed only by molybdenum. The electron-emitting device B had the resistive layer 9A composed of the molybdenum layer and the oxide layer provided on its surface.

FIG. 12 illustrates a supply arrangement of a power source at the time of measuring an electron emission characteristic. Vf is a voltage to be applied between the gate electrode 5 and the cathode electrode 2, If is a device current flowing at this time, Va is a voltage to be applied between the cathode electrode 2 and an anode 20, and Ie is an electron emission current.

The gate electrode 5 was defined to be 0 V and a negative voltage of the cathode electrode 2 was gradually raised from 0 V to −30 V, and If flowing at this time was measured. A rectangular wave was output as the voltage by using any waveform apparatus and was synchronized with an oscilloscope so that a current waveform and a voltage waveform were obtained.

The electron-emitting devices A and B manufactured in this example were heated in vacuum in advance. Thereafter, the characteristics were evaluated in a super-high vacuum (10⁻⁶ Pa or lower).

The voltage-current curves measured by the evaluation system are shown in FIG. 11.

Vf on an abscissa axis is the applied voltage, and If is the device current. When If-Vf curves are compared, it is found that the current-voltage curve of the electron-emitting device B shifts to a high-voltage side with respect to the current-voltage curve of the electron-emitting device A.

It is found that the resistance of the electron-emitting device B where the oxide layer is present on the surface layer becomes higher than that of the electron-emitting device A.

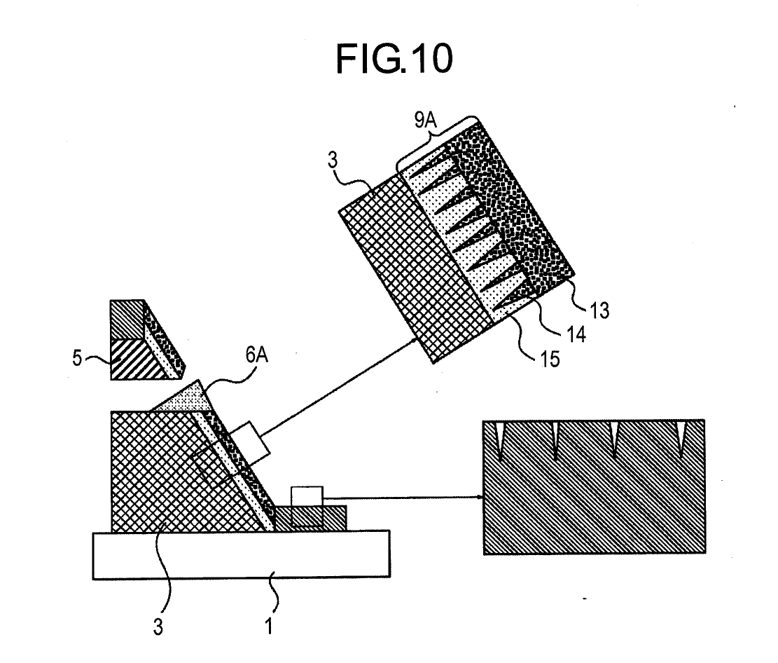

FIG. 10 typically illustrates results of checking the state after the oxide layer of the electron-emitting device B was etched by means of a cross-section TEM.

In the resistive layer 9A, the film thickness of the molybdenum layer 15 was 10 nm, and an average film thickness of the molybdenum oxide layer 13 present on the surface of the molybdenum film was 5 nm. Reference numeral 14 was the molybdenum oxide present between grains (crystallite) of the molybdenum film 15. A lot of oxide portions of the molybdenum were present not only the oxide layer 13 on the surface layer but also between the grains (crystallite) of the molybdenum layer 15. We consider that this dispersion of oxide in the metal contributes to heightening of the resistance.

The molybdenum oxide layer 13 was mainly composed of molybdenum dioxide. This was because the content was molybdenum trioxide at a stage that the oxide layer was formed, but the molybdenum trioxide was heated at 450° C. for one hour in vacuum so as to be altered into the molybdenum dioxide mainly (see Handbook of Materials and Techniques for Vacuum Devices p 287 Walter H. Kohl). The molybdenum oxide layer 13 may be composed of only molybdenum dioxide.

From the above viewpoints, a molybdenum dioxide layer (the layer mainly contains molybdenum dioxide) 13 is provided onto the surface of the resistive layer 9A, so that the function as the resistive layer is improved.

### Example 4

Since the method of manufacturing the electron-emitting device in this example is the same as that in the example 3, only a difference from the example 3 is described with reference to FIGS. 8A to 8G. In the electron-emitting devices A and B manufactured in this example, the conductive film (the electron-emitting member 6A and the resistive layer 9A) was patterned to be divided into 100 pieces. Except for this, the manufacturing method in this example is similar to the method of manufacturing the electron-emitting devices A and B in the example 3. Therefore, the patterning step is described below.

After a conductive peeling layer was peeled, in order to divide the conductive film (the electron-emitting member 6A and the resistive layer 9A) into 100 pieces, as shown in FIGS. 2A and 2B, a resist pattern was formed by the photolithography technique so that line and space with width T4 of 3 μm were formed.

Thereafter, patterning was performed by dry etching in such a manner that the conductive film (the electron-emitting member 6A and the resistive layer 9A) was divided into 100 pieces.

As a result of the analysis using the cross-section TEM, the shortest distance 8 between the end of the electron-emitting member as the electron-emitting portion (in FIG. 2B, corresponding to 60A1 to 60A4) and the gate electrode 5 was averagely 8.5 nm.

The other steps were the same as those in the example 2.

Since the method of evaluating the electron emission characteristics of the electron-emitting devices A and B manufactured at the above steps is approximately similar to that in the example 3, only a difference from the example 3 is described.

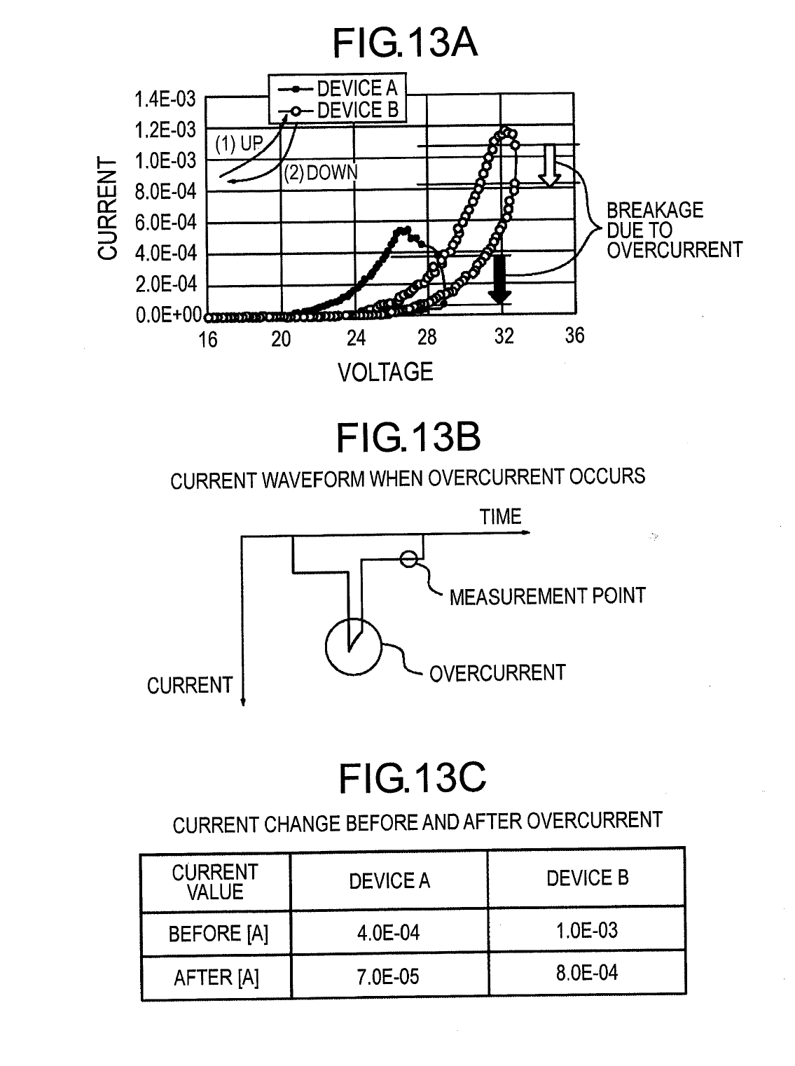

FIG. 13A illustrates an electric characteristic at the time when overcurrent flows in the two electron-emitting devices manufactured in this example (the electron-emitting devices A and B).

In order to measure the overcurrent, an oscilloscope B which was different from the oscilloscope A which was synchronized with any waveform generating apparatus was prepared. The oscilloscope B was set so as to be triggered when a value of the overcurrent of about 1 mA was superimposed on an FN current.

A sampling rate was set to 100 MSa/s and a record length was set to 14 bit. The If-Vf curves shown in FIG. 13A was obtained by reading latter half values of a pulse of the current waveform read by the oscilloscope A. An output pulse was 100 us, and a value obtained by averaging 5 us which was the pulse latter half was used as a read value.

The voltage was raised until overcurrent flowed, and when the overcurrent flowed in the oscilloscope B and the oscilloscope B was triggered, the rise in the voltage was stopped and the voltage was gradually lowered.

When the overcurrent flowed, a waveform as shown in FIG. 13B was obtained in oscilloscope B. FIG. 13C shows a difference in the current value between before and after the overcurrent flowed.

From FIG. 13C, the reduction in the current value was smaller in the electron-emitting device B provided with the resistive layer 9A having the oxide film on the upper layer. When the short-circuited resistive layer was fused instantaneously, damage to another adjacent resistive layer (electron-emitting member) was suppressed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2008-324463, filed on Dec. 19, 2008, which is hereby incorporated by reference here in its entirety.

1. An electron-emitting device comprising:
a cathode electrode;
an electron-emitting member which is electrically connected to the cathode electrode; and
a resistive layer provided between the cathode electrode and the electron-emitting member, wherein
the resistive layer is composed of the same material as that of the electron-emitting member, and film density of the resistive layer is lower than film density of the electron-emitting member.

2. An electron-emitting device according to claim 1, further comprising:
an insulating layer having an upper surface and a side surface connected to the upper surface,
wherein at least a part of the electron-emitting member is provided onto the upper surface, and the resistive layer is provided onto the side surface.

3. An electron-emitting device according to claim 2, wherein
a gate electrode is provided onto the insulating layer via a second insulating layer different from the insulating layer,
a conductive film is provided onto the gate electrode.

4. An electron-emitting device according to claim 1, wherein the material composing the electron-emitting member is molybdenum.

5. An electron-emitting device according to claim 1, wherein the film density of the resistive layer is not less than 6.0 g/cm³ and not more than 8.5 g/cm³, and the film density of the electron-emitting member is not less than 8.6 g/cm³ and not more than 10.3 g/cm³.

6. An electron-emitting device according to claim 1, wherein the resistive layer has a molybdenum oxide layer on its surface.

7. An electron-emitting device according to claim 6, wherein the molybdenum oxide layer is mainly composed of molybdenum dioxide.

8. An electron-emitting device comprising:
a cathode electrode; and
a conductive film which is electrically connected to the cathode electrode and has an electron-emitting portion and a resistive portion, wherein
film density of the resistive portion is lower than film density of the electron-emitting portion.

9. An electron-emitting device according to claim 8, further comprising:
an insulating layer having an upper surface and a side surface connected to the upper surface,
wherein the conductive film extends from the upper surface to the side surface, the electron-emitting portion is provided onto the upper surface and the resistive portion is positioned on the side surface.

10. An electron-emitting device according to claim 8, wherein the film density of the resistive portion is not less than 6.0 g/cm³ and not more than 8.5 g/cm³, and the film density of the electron-emitting portion is not less than 8.6 g/cm³ and not more than 10.3 g/cm³.

11. An image display apparatus comprising:
a plurality of electron-emitting devices; and
a light-emitting member which emits light by irradiation of electrons emitted from the electron-emitting device, wherein
the electron-emitting device is the electron-emitting device according to claim 1.

12. An image display apparatus comprising:
a plurality of electron-emitting devices; and
a light-emitting member which emits light by irradiation of electrons emitted from the electron-emitting device, wherein
the electron-emitting device is the electron-emitting device according to claim 8.
